(19) United States
(12) Patent Application Publication
(10) Pub. No.: US 2008/0069740 A1
(43) Pub. Date: Mar. 20, 2008

(54) GAS GENERATOR FOR RESTRAINING DEVICE OF VEHICLE

(75) Inventors: Kenji KITAYAMA, Tatsuno-shi (JP); Masato HIROOKA, Tatsuno-Shi (JP); Nobuyuki OHJI, Tatsuno-Shi (JP)

Correspondence Address: BIRCH STEWART KOLASCH & BIRCH, PO BOX 747, FALLS CHURCH, VA, 22040-0747, US

(73) Assignee: DAICEL CHEMICAL INDUSTRIES, LTD., Osaka-Shi (JP)

(21) Appl. No.: 11/850,554

(22) Filed: Sep. 5, 2007

Related U.S. Application Data
(60) Provisional application No. 60/842,157, filed on Sep. 5, 2006.

(30) Foreign Application Priority Data
Sep. 5, 2006 (JP) 2006-239744

(51) Int. Cl. B01J 7/00

(52) U.S. Cl. 422/163

(57) ABSTRACT

The present invention provides a gas generator for a restraining device of a vehicle including: a combustion chamber accommodating therein a solid gas generating agent and an igniter for igniting and combusting the solid gas generating agent, the solid gas generating agent being a single columnar body as a whole formed by an assembly of a plurality of sold gas generating agent units, each unit being at least arranged in the axial direction of the combustion chamber, one end surface of the solid gas generating agent facing an ignition portion of the igniter, the other end surface thereof facing a closed outlet of the combustion chamber.

This nonprovisional application claims priority under 35 U.S.C. § 119(a) on Patent Application No. 2006-239744 filed in Japan on 5 Sep. 2006 and 35 U.S.C. § 119(e) on U.S. Provisional Application No. 60/842,157 filed on 5 Sep. 2006, which are incorporated by reference.

### BACKGROUND OF INVENTION

1. Field of Invention

The present invention relates to a gas generator for a restraining device of a vehicle, such as an airbag apparatus.

2. Description of Related Art

An inflator using a plurality of lump-like gas generating agents arranged in the axial direction is known. For example, the structure shown in FIG. 1 of JP-A No. 5-213148 is known.

A gas generating agent 6 and filters 2, 4 are disposed inside a housing 15 provided with a plurality of gas outflow holes 17. The gas generating agent 16 is provided by arranging, in the axial direction, a plurality of gas generating agents each having a through hole in the central portion.

Adjacently to an ignition device 11, a first ignition agent 7 is disposed at one end of the gas generating agent 6, and a second ignition agent 9 is disposed at the opposite side. When the ignition device 11 is actuated, the first ignition agent 7 is ignited, the combustion energy thereof passes through a through hole to cause combustion of the second ignition agent 9, and the gas generating agent 6 is combusted from both ends.

### SUMMARY OF INVENTION

The present invention provides a gas generator for a restraining device of a vehicle comprising a combustion chamber accommodating therein a solid gas generating agent and an igniter for igniting and combusting the solid gas generating agent, the solid gas generating agent being a single columnar body as a whole formed by an assembly of a plurality of sold gas generating agent units, each unit being at least arranged in the axial direction of the combustion chamber, one end surface of the solid gas generating agent facing an ignition portion of the igniter, the other end surface thereof facing a closed outlet of the combustion chamber.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 shows an axial sectional view of the gas generator in accordance with the present invention;

FIG. 2 shows an axial sectional view of the gas generator that is another embodiment of the present invention;

FIG. 3 shows a partial sectional view in the axial direction of the igniter used in the gas generators shown in FIG. 1 and FIG. 2;

FIG. 4 shows a plane view of a solid gas generating agent that can be used in the gas generator shown in FIG. 2; and

FIG. 5 shows a plane view of another solid gas generating agent that can be used in the gas generator shown in FIG. 2.

### DETAILED DESCRIPTION OF INVENTION

In JP-A No. 5-213148, a plurality of gas outflow holes 17 are formed in the axial direction in a circumferential wall portion of a housing 15. Combustion gas is generated from the gas generating agent 6 that started combusting from both ends thereof, and the combustion gas is discharged from the gas outflow holes that are located close to the both ends of the gas generating agent 6 which has started combustion initially. As a result, in such structure, the gas is discharged comparatively easily and pressure is difficult to confine inside the housing. This is apparently why it is difficult for the initial ignition and combustion to proceed smoothly.

The present invention relates to a gas generator for a restraining device of a vehicle in which improvement of ignition ability and stability of output in the case of using a lump-like gas generating agent can be ensured, output rises rapidly, and a maximum output can be increased.

The solid gas generating agent in the present invention is an assembly of a plurality of solid gas generating agent units and is, as a whole, a single columnar body. The adjacent units among a plurality of solid gas generating agent units are in contact with each other, all the units are assembled by being stacked in the longitudinal direction or arranged side by side in the transverse direction, whereby a single columnar solid gas generating agent is formed. No specific limitation is placed on the number of solid gas generating agent units, and there can be two to ten units, preferably two to six units, even more preferably two to four units.

One solid gas generating agent unit is a plate having a desired thickness, and this plate may have a round planar shape or a polygonal or elliptical shape close to a round shape. The solid gas generating agent units may have identical or different thicknesses, and two to six such units can be assembled. For example, when two solid gas generating agent units are assembled, the thickness ratio can be selected within a range of 2:8 to 8:2.

Where solid gas generating agent units with a small thickness (length) are used, the strength of one solid gas generating agent unit decreases and at least the solid gas generating agent unit facing the ignition portion of the igniter, is easily broken. As a result, surface area increases, combustion efficiency rises, and the amount of heat generated per unit time increases, thereby increasing the maximum output and also increasing the output increase rate. Because of such a feature, the gas generator is suitable for side collision airbags and curtain airbags.

The igniter is disposed at one end of the combustion chamber accommodating the solid gas generating agent in accordance with the present invention, and the combustion chamber has a closed outlet at the other end. Further, one end surface of the solid gas generating agent faces (preferably directly faces) the ignition portion of the igniter, and the other side faces (preferably directly faces) the closed gas outlet.

With such an arrangement, the solid gas generating agent unit, that is close to the ignition portion, receives the combustion products (flame, shock wave, high-temperature gas, and the like) generated when the igniter is actuated and is combusted and at the same time broken and the combustion thereof generates gas, but by contrast with the invention of JP-A No. 5-213148, the gas outlet is not located close and the combustion gas has to reach the combustion chamber outlet located on the opposite side. Therefore, the inner pressure of the combustion chamber easily rises and the gas generating agent is easily ignited and combusted.

On the other hand, the solid gas generating agent unit located close to the combustion chamber outlet is hardly affected by the combustion products generated due to actuation of the igniter and is apparently more difficult to be broken than the solid gas generating agent unit that is close to the igniter. However, the solid gas generating agent unit located close to the combustion chamber outlet apparently acts as a “blocking wall” that physically blocks the discharge of the broken solid gas generating agent unit, that has been located in a position close to the igniter, from the combustion chamber outlet in a non-combusted state (that is, in a broken state that has not been completely combusted).

Because the gas generating agent unit located in the vicinity of igniter is broken and combusted, and the internal pressure of the combustion chamber rises. Therefore, the gas generating agent unit located in the vicinity of the combustion chamber outlet will apparently be easily ignited and combusted even when the degree of breaking is low.

Further, a booster or transfer charge that enhances ignition and combustion of the solid gas generating agent can be also used in addition to the ignition agent that has been loaded into the ignition portion of the igniter, but the absence of the aforementioned booster or transfer charge between the ignition portion and solid gas generating agent is preferable to solve the problem and to obtain a preferable effect of the present invention.

The present invention further relates to the gas generator for a restraining device of a vehicle, wherein the solid gas generating agent is a columnar body having a through hole in the lengthwise direction.

In the case where the solid gas generating agent has a through hole, contact surface area with the combustion products increases and, therefore, ignition performance can be improved. Further, where the through hole is present, the aforementioned “blocking wall” effect may not be sufficiently demonstrated. Therefore, only the solid gas generating agent unit in a position closest to the combustion chamber outlet may not have a hole. Further, because the through hole serves as a flow path to the combustion chamber outlet for the gas generated by the combustion of gas generating agent unit in the vicinity of the igniter, the amount of gas reaching the outlet or the function of the unit as a blocking wall may be adjusted by adjusting the inner diameter of the through hole.

The present invention further relates to the gas generator for a restraining device of a vehicle, wherein

at least part of a circumferential surface and part of an end surface of the solid gas generating agent come into contact with an inner wall surface of the combustion chamber, thereby preventing the solid gas generating agent from moving in the axial direction and the radial direction.

With such configuration, the solid gas generating agent is prevented from colliding with the inner wall of the combustion chamber and generating noise, and breaking of the solid gas generating agent by repetition of such collisions is prevented.

Further, if a gap is present between the solid gas generating agent and inner wall surface of combustion chamber, then the contact state of the solid gas generating agent and combustion products becomes non-uniform depending on the gap appearance state. For this reason, the combustion state becomes non-uniform and the output of the gas generator varies. Further, where the entire circumferential surface of solid gas generating agent comes into contact with the inner wall of combustion chamber, combustion products do not come anymore into contact with zones other than the end surface of the solid gas generating agent, or the end surface of the agent and the inner wall surface of the through hole (for example, inner wall surface of combustion chamber). The combustion state can be therefore easily controlled. As a result, in addition to the above-described movement preventing effect, a contribution can be made to inhibit variation of output.

The present invention further relates to the gas generator for a restraining device of a vehicle, wherein

the ignition portion of the igniter has a cylindrical charge holder and an ignition agent loaded into the cylindrical charge holder, and the cylindrical charge holder and the ignition agent are covered with a cup member; and

an opening of the cylindrical charge holder is located opposite to an end portion of the solid gas generating agent.

Providing with such a charge holder, makes it possible to control the ejection direction of combustion products to the opening direction of charge holder. Therefore, combustion products can be concentrated on one end surface of the solid gas generating agent present in the opening direction. Therefore, breaking effect of the solid gas generating agent is increased.

The present invention further relates to the gas generator for a restraining device of a vehicle, wherein

the ignition portion of the igniter has a cylindrical charge holder and an ignition agent loaded into the cylindrical charge holder, and the cylindrical charge holder and the ignition agent are covered with a cup member; and

an inner diameter of the charge holder is smaller than an outer diameter of the solid gas generating agent and larger than an inner diameter of the through hole.

By adjusting the inner diameter of the charge holder, the outer diameter of the solid gas generating agent, and the inner diameter of the through hole, it is possible to improve ignition ability of the solid gas generating agent.

The gas generator in accordance with the present invention uses a solid gas generating agent combining at least two solid gas generating agent units. Therefore, the gas generating agent can be easily loaded when the gas generator is assembled and ignition ability of the solid gas generating agent is improved. As a result, the output of the gas generator during actuation rises rapidly, the maximum output can be increased, and output can be stabilized.

### EMBODIMENT OF INVENTION

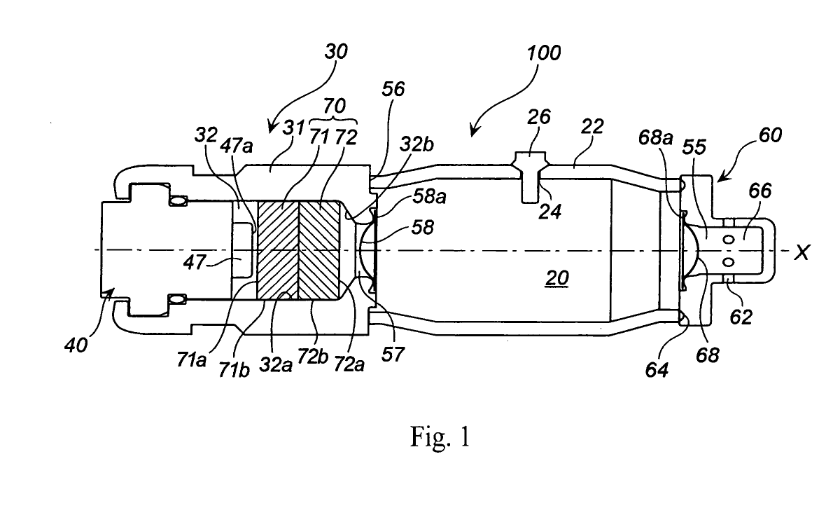

(1) Gas Generator of FIG. 1

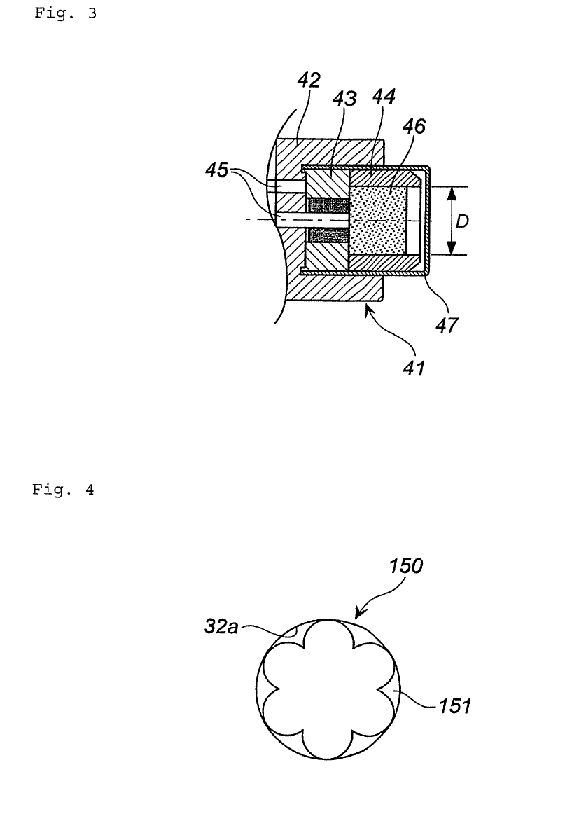

The gas generator in accordance with the present invention will be explained below with reference to FIG. 1 and FIG. 3. FIG. 1 is an axial sectional view of the gas generator in accordance with the present invention. FIG. 3 is an axial sectional view of the igniter used in the gas generator shown in FIG. 1. The gas generator shown in FIG. 1 is suitable for use in combination with an air bag for a side collision.

A gas generator 100 has a pressurized gas chamber 20 filled with pressurized gas, a gas generation chamber 30 in which a solid gas generating agent 70 is disposed, and a diffuser portion 60.

In the pressurized gas chamber 20, an outer shell is formed by a pressurized gas chamber housing 22 that has a cylindrical shape and a round cross section, and the chamber is filled with a pressurized gas including a mixture of argon and helium. The pressurized gas chamber housing 22 is symmetrical in the axial and radial directions.

A charging hole 24 for the pressurized gas is formed in a side surface of the pressurized gas chamber housing 22. This hole is closed by a pin 26 after the pressurized gas has been charged.

In the gas generation chamber 30, an outer shell is formed by a gas generation chamber housing 31, and the inside thereof serves as a combustion chamber 32. The gas generation chamber housing 31 and pressurized gas chamber housing 22 are resistance-welded in a joint portion 56.

An electric igniter 40 is attached to one end of the combustion chamber 32 (gas generation chamber housing 31); the ignition portion of the igniter 40 is covered with a cup 47 (sometimes referred to hereinbelow as “ignition portion 47”) and protrudes into the combustion chamber 32. A known igniter that has been generally used in a gas generator of an airbag apparatus can be used as the igniter 40, and an igniter having a structure such as shown in FIG. 3 can be used.

In the igniter 40, an igniter main body 41 is fixed to a metal collar via a resin 42. The igniter main body 41 has a metal header 43, a cylindrical charge holder 44, and a pair of conductive pins 45 for connection to an external power source. The conductive pins 45 are disposed in a state of electric insulation from each other, and distal ends thereof are bridged with a bridge wire (not shown in the drawings). The charge holder 44 also acts to control the ejection direction of combustion products.

An ignition agent (for example, an explosive including zirconium and potassium perchlorate) 46 is loaded, in a state of contact with the bridge wire, into a cavity formed by the metal header 43 and cylindrical charge holder 44. The metal header 43, cylindrical charge holder 44, and ignition agent 46 are then covered with the cup 47. A portion covered with the cup 47 and generating combustion products during actuation of the igniter 40 serves as an ignition portion (ignition portion 47).

A cup made from a metal (aluminum or the like) or a non-metal (synthetic resin or the like) can be used as the cup 47, but when a metal cup is used as the cup 47, a thin insulating film is formed on the surface of cup 47 to maintain electric insulation.

The solid gas generating agent 70 is accommodated inside the combustion chamber 32. In the solid gas generating agent 70, two units, namely, a first solid gas generating agent unit 71 and a second solid gas generating agent unit 72, are in contact with each other and disposed side by side in the X axis direction, thereby forming as a whole a single solid gas generating agent. The first solid gas generating agent unit 71 and second solid gas generating agent unit 72 have the same composition, dimensions and shape.

An end surface 71a of the first solid gas generating agent unit 71 directly faces the ignition portion 47 of the igniter 40. An end surface 72a of the second solid gas generating agent unit 72 directly faces a first rupturable plate 58 (which closes a first communication hole 57 serving as an outlet of the combustion chamber 32). As shown in the drawing, the outer diameter of the ignition portion 47 is smaller than the outer diameter of the end surface 71a.

The solid gas generating agent 70 is accommodated so that a circumferential surface 71b of the first solid gas generating agent unit 71 and a circumferential surface 72b of the second solid gas generating agent unit 72 are in contact with an inner wall surface 32a of the combustion chamber 32, and a circumferential edge portion of the end surface 72b is in contact with an inner wall inclined surface 32b. Because the outer diameter of the solid gas generating agent 70 is almost equal to the inner diameter of the combustion chamber 32, the circumferential surfaces 71b, 72b abut against the inner wall surface 32a of the combustion chamber 32. Therefore, the solid gas generating agent 70 is prevented from moving in the radial direction and toward the pressurized gas chamber 20, and even when external vibrations are applied to the gas generator 100, the solid gas generating agent 70 is prevented from moving and generating noise or breaking.

By inserting a donut-shaped cushion member between the end surface 71a and igniter 40, it is possible to form a gap between the end surface 71a and a top surface 47a of the ignition portion. In this case, the top surface 47a is positioned in an orifice portion of the donut-shaped cushion member, and only a circumferential edge portion of the end surface 71a comes into contact with an annular surface of the cushion member, so that combustion of the solid gas generating agent 70 is not inhibited. The cushion member may be flammable or nonflammable, but is preferably a flammable member made of silicone or the like.

Gas generating agents of known compositions disclosed in JP-A No. 2001-226188 and JP-A No. 2004-155645 can be used as the solid gas generating agent 70 (and the first solid gas generating agent unit 71, the second solid gas generating agent unit 72).

The first communication hole 57 (outlet of combustion chamber 32) located between the pressurized gas chamber 20 and gas generation chamber 30 is closed with the first rupturable plate 58, and the inside of the gas generation chamber 30 is maintained under an ambient pressure. The first rupturable plate 58 is resistance-welded to the gas generation chamber housing 31 in the circumferential edge portion 58a. Pressure of the pressurized gas loaded into the pressurized gas chamber 20 causes the first rupturable plate to be deformed into a bowl-like shape toward the gas generation chamber 30.

A diffuser portion 60 having a gas discharge hole 62 for discharging the pressurized gas and combustion gas is connected to the other end of the pressurized gas chamber 20, and the diffuser portion 60 and pressurized gas chamber housing 22 are resistance-welded in a connecting portion 64. The diffuser portion 60 is formed as a cap having a plurality of gas discharge holes 62 through which gases pass.

A second communication hole 66 located between the pressurized gas chamber 20 and diffuser portion 60 is closed with a second rupturable plate 68, and the inside of the diffuser portion 60 is maintained under an ambient pressure. The second rupturable plate 68 is resistance-welded to the diffuser portion 60 in the circumferential edge portion 68a, and bowl-like deformed toward the diffuser 60 due to the pressure of the pressurized gas loaded into the pressurized gas chamber 20.

Operation of the gas generator 100 shown in FIG. 1 when the gas generator is assembled with an airbag system installed on an automobile will be described below.

When an automobile collides and receives the impact, the igniter 40 is actuated and ignited by an actuation signal output device, and combustion products discharged from the ignition portion 47 collide with the end surface 71a of the first solid gas generating agent unit 71. As a result, the first solid gas generating agent unit 71 is broken and combustion thereof is started in the broken state. The structure shown in FIG. 3 is preferably used as the ignition portion 47 because the discharge direction of combustion products can be controlled to be discharged toward the end surface 71a of the first solid gas generating agent unit 71 by the charge holder 44.

Due to combustion of the first solid gas generating agent unit 71, pressure inside the combustion chamber 32 rises and the first rupturable plate 58 is ruptured. However, because the second solid gas generating agent unit 72, which combustion products do not directly collide with, is not broken easily comparing to the first solid gas generating agent unit 71. For this reason the presence of the second solid gas generating agent unit 72 prevents non-combusted broken pieces from entering the pressurized gas chamber 20 through the first communication hole 57 after the first rupturable plate 58 has been ruptured.

On the other hand, after combustion of the broken first solid gas generating agent unit 71 advances to a certain degree and pressure inside the combustion chamber 32 rises, the broken agent that has been combusted with a high combustion efficiency comes into contact with the second solid gas generating agent unit 72. As a result, the second solid gas generating agent unit 72 becomes easily ignited and combusted and the ratio of agent that is discharged in a non-combusted state is decreased.

As the solid gas generating agent 70 including the first solid gas generating agent unit 71 and second solid gas generating agent unit 72 is combusted and generates gas, pressure inside the combustion chamber 32 rises and the first rupturable plate 58 is ruptured. The combustion gas reaches the inside of the pressurized gas chamber housing 22 and mixes with the pressurized gas, thereby further raising pressure. The resultant gas mixture ruptures the second rupturable plate 68 and is discharged from the diffuser 60.

In the gas generator 100 in accordance with the present invention, gas is released from the inside of the combustion chamber 32 after the solid gas generating agent 70 including the first solid gas generating agent unit 71 and second solid gas generating agent unit 72 has been almost entirely combusted, and non-combusted broken pieces are prevented from being released from the inside of the combustion chamber 32. Therefore, in the gas generator 100, output rises rapidly, maximum output is further increased, and output variation is decreased.

Variations of maximum pressures were compared between the gas generator 100 in FIG. 1, using two solid gas generating agent units 71, 72, each having an outer diameter of 13 mm and a length of 4 mm, and the same gas generator 100, however, using a single gas generating agent having the same dimension as the above as a whole (an outer diameter of 13 mm and a length of 8 mm) by a known 60 liter tank combustion test. As a result, the gas generator using the two solid gas generating agent units 71, 72 had the less variation in the maximum pressure and the more stable output was obtained.

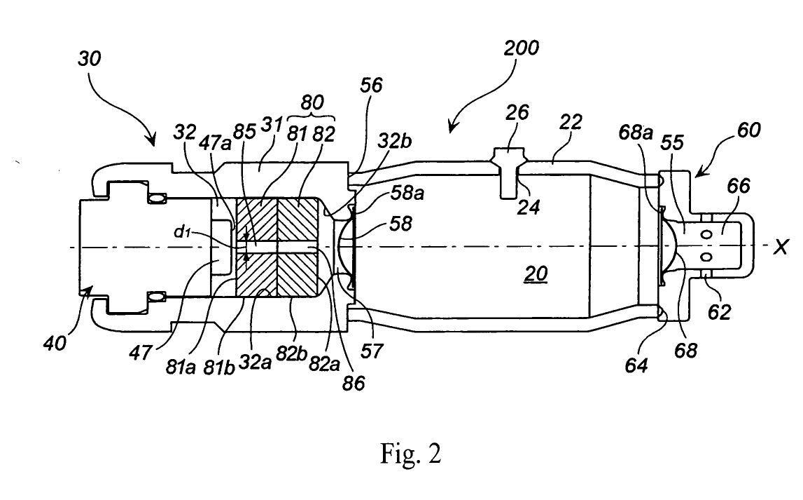

(2) Gas Generator of FIG. 2

A gas generator of the present invention will be described below with reference to FIGS. 2 to 5. □FIG. 2 is an axial cross-sectional view of a gas generator that is another embodiment of the present invention. Basic structure of this gas generator is identical to that shown in FIG. 1, and only the form of the solid gas generating agent is different. The numerals identical to those in FIG. 1 denote identical components. The gas generator of FIG. 2 is suitable for being used in combination with an air bag for side collisions.

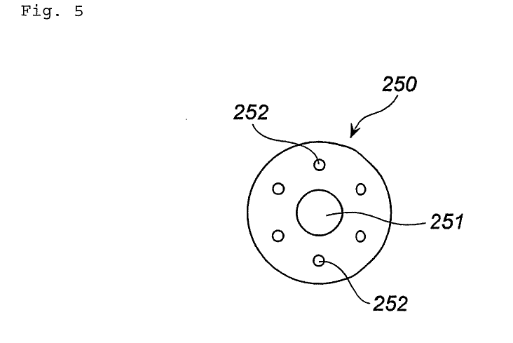

FIG. 3 is a sectional view in the axial direction of the igniter used in the gas generator shown in FIG. 2. FIG. 4 and FIG. 5 are plan views of solid gas generating agents that can be used in the gas generator in accordance with the present invention.

In a gas generator 200 of FIG. 2, a solid gas generating agent 80 includes two solid gas generating agent units, namely, a first solid gas generating agent unit 81 having a through hole 85 in the central portion and a second solid gas generating agent unit 82 having a through hole 86 in the central portion, the two units being disposed in contact with each other and constituting, as a whole, a single solid gas generating agent. The first solid gas generating agent unit 81 and second solid gas generating agent unit 82 have the same composition, dimensions and shape.

An end surface 81a of the first solid gas generating agent unit 81 directly faces, via a gap, an ignition portion 47 of an igniter 40. An end surface 82a of the second solid gas generating agent unit 82 directly faces a first rupturable plate 58 (which closes a first communication hole 57 serving as an outlet of a combustion chamber 32). As shown in the drawing, the outer diameter of the ignition portion 47 is smaller than the outer diameter of the end surface 81a.

The solid gas generating agent 80 is accommodated so that a circumferential surface 81b of the first solid gas generating agent unit 81 and a circumferential surface 82b of the second solid gas generating agent unit 82 are in contact with an inner wall surface 32a of the combustion chamber 32, and a circumferential edge portion of the end surface 82a is in contact with an inner wall inclined surface 32b. Because the outer diameter of the solid gas generating agent 80 is almost equal to the inner diameter of the combustion chamber 32, the circumferential surfaces 81b, 82b abut against the inner wall surface 32a of the combustion chamber 32. Therefore, the solid gas generating agent 80 is prevented form moving in the radial direction and toward a pressurized gas chamber 20, and even when external vibrations are applied to the gas generator 200, the solid gas generating agent 80 is prevented from moving and generating noise or breaking.

By inserting a donut-shaped cushion member between the end surface 81a and igniter 40, it is possible to form a gap between the end surface 81a and a top surface 47a of the ignition portion. In this case, the top surface 47a is positioned in an orifice portion of the donut-shaped cushion member, and only a circumferential edge portion of the end surface 81a comes into contact with an annular surface of the cushion member, so that combustion of the solid gas generating agent 80 is not inhibited. The cushion member may be flammable or nonflammable, but is preferably a flammable member formed of silicone or the like.

In the gas generator 200 shown in FIG. 2, the central axis X of gas generator 200, the central axis of through hole 85, the central axis of through hole 86, and the central axis of igniter 40 coincide. However, it is important that the two solid gas generating agent units 81, 82 be used in combination, and the through holes 85, 86 may be omitted. Therefore, it is not necessary for the central axis of gas generator 100, the central axis of through hole 85, the central axis of through hole 86, and the central axis of igniter 40 to coincide. Furthermore, a through hole may be present only in one of the solid gas generating agent units 81, 82, and solid gas generating agent units 81, 82 may be different in the diameter of respective through holes, number of through holes, and formation positions of through holes.

The inner diameter D (for example, 4 mm) of a charge holder 44 in an ignition portion (cup) 47 is set larger than the inner diameter d₁ (for example, 3 mm) of through holes 85, 86 (D>d₁). By satisfying this dimensional relationship, it is possible to prevent the ignition portion 47 of the igniter from entering the through hole 85 even when the solid gas generating agent 80 moves toward the igniter 40.

In addition to the shape shown in FIG. 2, the solid gas generator 80 may have the shape such as shown in FIG. 4 and FIG. 5.

Because the solid gas generating agent 150 has a petal planar shape, a space 151 is formed between the agent and the inner wall surface 32a when the agent is accommodated in the combustion chamber 32. This space 151 is equivalent to the through holes 85, 86 of the gas generating agent 80 used in the gas generator 200 shown in FIG. 2.

A through hole may be formed in the central portion of the solid gas generating agent 150, as in the solid gas generating agent 80 shown in FIG. 2. For example, a plurality (for example, six to ten) columnar molded articles may be disposed circumferentially (an almost star-like through hole is formed in the central portion) and integrated to form a single unit, and a plurality of such units can be assembled.

When the solid gas generating agent 150 shown in FIG. 4 is applied to the gas generator 200 shown in FIG. 2, the arrangement is made such that the central axis of the igniter 40 and the central axis of the solid gas generating agent 150 coincide. And the space 151 is formed continuously from one end (the igniter 40 side) to the other end (the first rupturable plate 58 side).

The solid gas generating agent 250 shown in FIG. 5 has a through hole 251 in the central portion of a columnar molded body, and a plurality (six in FIG. 5) of through holes 252, which have an inner diameter less than that of the through hole 251, are arranged around the through hole 251. By thus forming a plurality of through holes with different inner diameters, the total surface area of the inner wall surface of all the through holes is increased and, therefore, the ignition ability is improved. Further, in order to prevent combustion products from passing via the through holes, it is preferred than the inner diameter of the through hole 251 be 6.5 mm or less, and the inner diameter of the through hole 252 be 3.5 mm or less.

When the solid gas generator 250 shown in FIG. 5 is applied to the gas generator 200 shown in FIG. 2, the arrangement is made such that the central axis of the igniter 40 and the central axis of the through hole 251 coincide.

Operation of the gas generator 200 shown in FIG. 2 when the gas generator 200 is assembled with an airbag system installed on an automobile will be described below. The gas generator 200 is actuated in almost the same manner as the gas generator 100 of FIG. 1, but because the solid gas generating agent 80 has through holes 85, 86, ignition ability of the second solid gas generating agent unit 82 located at a larger distance from the igniter 40 is improved with respect to that of the second gas generating agent unit 72 of the solid gas generator 70 (see FIG. 1).

Further, combustion gas generated from the first solid gas generating agent unit 81 easily reaches the first rupturable plate 58 via the through hole 86. However, because the diameter of the through hole 86 is small, the broken first solid gas generating agent unit 81 hardly passes through the through hole 86 and is hardly discharged into the pressurized gas chamber 20.

Variations of maximum pressures were compared between the gas generator 200 in FIG. 2 using two solid gas generating agents units 81, 82, each having an outer diameter of 13 mm, an inner diameter (diameter of the through hole) of 3 mm and a length of 4 mm and the same gas generator 200, however, using a single gas generating agent having the same dimension as the above as a whole (an outer diameter of 13 mm, a length of 8 mm and an inner diameter (diameter of the through hole) of 3 mm) by a known 60 liter tank combustion test. As a result, the gas generator using the two solid gas generating agent units 81, 82 had the less variation in the maximum pressure and the more stable output was obtained.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A gas generator for a restraining device of a vehicle comprising:
a combustion chamber accommodating therein a solid gas generating agent and an igniter for igniting and combusting the solid gas generating agent, the solid gas generating agent being a single columnar body as a whole formed by an assembly of a plurality of sold gas generating agent units, each unit being at least arranged in the axial direction of the combustion chamber, one end surface of the solid gas generating agent facing an ignition portion of the igniter, the other end surface thereof facing a closed outlet of the combustion chamber.

2. The gas generator for a restraining device of a vehicle according to claim 1, wherein the solid gas generating agent is a columnar body having a through hole in the lengthwise direction.

3. The gas generator for a restraining device of a vehicle according to claim 1, wherein at least part of a circumferential surface and part of an end surface of the solid gas generating agent come into contact with an inner wall surface of the combustion chamber, thereby preventing the solid gas generating agent from moving in the axial direction and the radial direction.

4. The gas generator for a restraining device of a vehicle according to claim 2, wherein at least part of a circumferential surface and part of an end surface of the solid gas generating agent come into contact with an inner wall surface of the combustion chamber, thereby preventing the solid gas generating agent from moving in the axial direction and the radial direction.

5. The gas generator for a restraining device of a vehicle according to claim 1, wherein
the ignition portion of the igniter has a cylindrical charge holder and an ignition agent loaded into the cylindrical charge holder, and the cylindrical charge holder and the ignition agent are covered with a cup member; and
an opening of the cylindrical charge holder is located opposite to an end portion of the solid gas generating agent.

6. The gas generator for a restraining device of a vehicle according to claim 2, wherein
the ignition portion of the igniter has a cylindrical charge holder and an ignition agent loaded into the cylindrical charge holder, and the cylindrical charge holder and the ignition agent are covered with a cup member; and
an opening of the cylindrical charge holder is located opposite to an end portion of the solid gas generating agent.

7. The gas generator for a restraining device of a vehicle according to claim 2, wherein
the ignition portion of the igniter has a cylindrical charge holder and an ignition agent loaded into the cylindrical charge holder, and the cylindrical charge holder and the ignition agent are covered with a cup member; and
an inner diameter of the charge holder is smaller than an outer diameter of the solid gas generating agent and larger than an inner diameter of the through hole.
